(19) United States
(12) Patent Application Publication
(10) Pub. No.: US 2015/0240548 A1
(43) Pub. Date: Aug. 27, 2015

(54) MOTOR VEHICLE DOOR AND METHOD FOR ACTING ON SUCH A MOTOR VEHICLE DOOR

(71) Applicant: KIEKERT AKTIENGESELLSCHAFT, Heiligenhaus (DE)

(72) Inventors: Thorsten Bendel, Oberhausen (DE); Michael Merget, Mettmann (DE)

(21) Appl. No.: 14/427,170

(22) PCT Filed: Sep. 13, 2013
(86) PCT No.: PCT/DE2013/000525

§ 371 Date: Mar. 10, 2015

(30) Foreign Application Priority Data
Sep. 13, 2012 (DE) 10 2012 018 093.4

(51) Int. Cl. E05F 15/70; E05C 17/00; E05D 11/10; E05F 5/00; E05F 1/00

(52) U.S. Cl. CPC E05F 15/70; E05F 5/00; E05F 1/002; E05D 11/1085; E05C 17/003; E05Y 2201/21; E05Y 2201/462; E05Y 2400/20

(57) ABSTRACT

The invention relates to a motor vehicle door and to a method for acting on said motor vehicle door in terms of braking/holding or pulling closed/opening. The motor vehicle door is equipped with a driven (4, 5; 4) door leaf (1), a magnetic arrangement (4) as component of the drive (4, 5; 4) and at least one sensor (6) assigned to the door leaf (1). According to the invention, on the basis of a speed and/or position of the door leaf (1) with respect to a motor vehicle body (2) detected by means of the sensor (6), the magnetic arrangement (4) is supplied with power by a control unit (7) for either braking or holding, or pulling closed or opening the door leaf (1).

### CROSS-REFERENCE TO RELATED APPLICATIONS

This application is the U.S. national stage application of International Patent Application No. PCT/DE2013/000525, filed Sep. 13, 2013, which claims priority of German Application No. 10 2012 018 093.4, filed Sep. 13, 2012, which are both hereby incorporated by reference.

### BACKGROUND

The invention relates to a motor vehicle door which is equipped with a driven door leaf and a magnetic arrangement as component of the drive and at least one sensor assigned to the door leaf.

A motor vehicle door of the above design is for instance disclosed in DE 10 2007 026 796 A1. This is a device for securing opened doors, flaps or similar of a motor vehicle. Furthermore, a braking and holding element is provided, containing frictional areas moveable in relation to each other. The frictional areas contain friction bodies consisting of magnetisable material. In addition, a closed magnetic flux can hold the frictional surfaces in a force application position. The magnetic flux is produced by an energisable coil generating a magnetic field. In addition, a sensor is provided with which the opening position of the respective door or flap is detected.

In the known teaching, the material of the friction body has a reversible ferro-magnetic property. This means that the magnetic flux remains even once the magnetic field produced by the coil has been switched off but can be cancelled again by the application of a counter magnetic field. Such friction bodies with ferro magnetic properties are generally costly and problematic as regards reliable functioning. Motor vehicles and their respective motor vehicle doors are after all used in all climatic zones of the earth and thus have to operate in temperature ranges of between −40° C. and 70° C. without problems. Due to the Curie effect this is problematic for friction bodies with ferro magnetic properties using reversibility. The Curie temperature of ferrites is actually around 100° C. and more depending on the composition of the material, so that it can be expected that the generated magnetic field will be adversely affected by temperature.

In a drive for a door leaf as disclosed in US 2006/0156630 A1, a planetary gear is provided, equipped with an electromagnetic brake. With the aid of this electromagnetic brake the movement of the drive for the door leaf can be stopped as required.

The state of the art also includes a door stop as disclosed in utility patent DE 20 2008 011 513 U1. In this door stop, the flux of force existing during the securing operation runs through a separating mechanism, containing a separable connection and, in particular a magnetic connection. This magnetic connection is, amongst other things, based on the magnetic attraction between a permanent magnet arrangement and a seat allocated to a permanent magnet arrangement.

The also relevant EP 1 249 637 B1 relates to a device for damping or suppressing vibrations in a moved system in particular a vehicle drive aggregate. For this purpose, a chamber filled with a magnetorheological fluid is provided in which a magnetic field can be generated. At least a partial section of the chamber contains several electric conductors in which a flow of current can be generated.

The so far known state of the art is—as regards achievable functional reliability and possible application scenarios in motor vehicles—to some extent problematic when taking into account all climatic conditions. The viscosity of the magnetorheological fluid does, for instance, change with temperature according to EP 1 249 637 B1 which could adversely affect functioning. According to DE 10 2007 026 796 A1 it can be assumed that the employed friction bodies with their reversible ferro magnetic properties can loose part of their magnetic force under high temperatures. Furthermore, magnetorheological fluids and friction bodies with reversible ferro magnetic properties are relatively costly to produce and thus unsuitable for mass applications, such as in motor vehicles. This also applies to the solution disclosed in US 2006/0156630 A1, which in this context uses a costly planetary gear. The invention aims to remedy this situation.

### SUMMARY

The invention is based on the technical problem of further developing a motor vehicle door and a method for acting on such a motor vehicle door in such a way that reliable operation is ensured with a simple and cost effective design.

In order to solve this technical problem, a generic motor vehicle door of the invention is characterised by the magnetic arrangement being energised by a control unit for selectively braking, holding, closing or opening the door leaf, depending on the speed and/or position of the door leaf in relation to a motor vehicle body as determined with the aid of a sensor. The said different operating states “braking, holding, closing, opening” can be individually or cumulatively realised and are thus—so to speak—connected by an “and/or” link.

The sensor can be a speed/position sensor. Typically a step counter or also an incremental encoder is used as a sensor. Such a sensor or step counter is not only able to transmit the position of the door leaf in relation to the motor vehicle body to the control unit, supplied with respective data but can also generally deduce the speed of the door leaf from the chronological order of the steps.

In this way the control unit is generally informed about the position of the door leaf and its speed. Naturally this data also includes information about the direction in which the door leaf is moving, i.e. in opening or closing direction. Based on this information, the control unit then ensures that the magnetic arrangement is supplied with current.

The magnetic arrangement contains at least two electric solenoids and additional permanent magnets, where applicable. As a result, a particularly simple and reliable arrangement is provided. Such electric solenoids and conventional permanent magnets are particularly robust and reliable as well as stable under different temperatures, at least with the usual area of application of motor vehicles and the associated temperature range.

In this arrangement, the electric solenoids can be optionally energised by the permanent magnets for mutual repelling or mutual attraction and/or, repelling/attraction. The individual different operating states such as braking or holding of the door leaf or closing and opening of the door leaf can thus be easily implemented. Equally, individually operating states can be realised together, for instance, in succession, e.g. “braking” followed by “closing”.

In this context, the magnetic arrangement or electric solenoids typically provided at this point are supplied with current in the usual manner depending on the signals of the sensor processed in the control unit and in the sense of a control. This means that the signals output by the sensor are continuously recorded by the control unit as a control variable and are compared with the reference variable generally stored in the control unit, i.e. the corresponding set values. The control is therefore provided by the signals of the sensor being adapted to the reference value.

Specifically this means that for instance the speed of the door leaf is braked to such an extent by the magnetic arrangement that the then reached speed of the door leaf or of the control variable corresponds to a reference value or generally a set value stored in the control unit. This set value can, for instance, specify or provide the desired speed of the door leaf.

Similarly, the controls can operate together with the control unit in such a way that the door leaf, starting from a closing movement from a certain position is no longer braked in relation to the motor vehicle body but is changed from the “brake” to a “close” mode. This change of mode typically occurs depending on the position of the door leaf in relation to the motor vehicle body that is detected with the aid of the sensor and can be determined in the control unit.

It is, for instance, feasible that the control unit together with the sensor differentiates between different angle ranges of the door leaf in relation to the motor vehicle body. The angle range provides the inverse angle of the door leaf in relation to the motor vehicle body, as the door leaf or the respective motor vehicle door is typically a pivotable side door. Generally, the same method can naturally also be used for a tailgate. The total pivoting angle across which the door leaf moves can, for instance, be divided into two ranges, i.e. a closing/opening range and a braking range. The closing/opening range can correspond to the pivoting angle of the door leaf in relation to the motor vehicle body of approx. 0° to approx. 10° or approx. 15° to 20°. In contrast, the braking range is part of the pivoting angles of the door leaf in relation to the motor vehicle body of 10° or 15° or 20° up to a maximum pivoting angle of, for instance, 80° or 90°.

As a result of this differentiation, the control unit is able to act on the magnet arrangement or the at least two electric solenoids provided in this context, in such a way that this ensures, for instance, that the door leaf is braked, provided that the door leaf is in the braking range and, for instance, carries out a manually specified closing movement. If, on the other hand, the door leaf moves from the deceleration range to the closing/opening range, the already described change of mode from “brake” to “close” occurs.

Conversely, the closing/opening range can also be used for the door leaf to be pushed out within the closing/opening range by means of the magnetic arrangement acted upon by the control unit. An operator can then, for instance, grip the pushed out door leaf and open it manually. Alternatively it is, however, also feasible that the door leaf is pushed out when moving through the closing/opening range, followed by a change of modes from “pushing out” to “opening” and in such a way that “opening” provides or can provide a separate opening actuator.

The magnetic arrangement can, in any case be energised in such a way that the door leaf is optionally slowed down, held, closed or opened or pushed out. These different modes can be easily provided by the invention as the two electric solenoids and, where applicable, the permanent magnets are optionally energised in the sense of a mutual repelling or attracting or in the sense of a repelling/attraction of the additional permanent magnets. As a result, the magnetic arrangement ultimately operates as a damping/braking/holding and drive arrangement. The drive and magnetic arrangement can also be congruent.

Depending on the position and speed of the door leaf in relation to the motor vehicle body, the control unit ensures that the magnet arrangement is acted upon for braking/holding or closing/opening. According to an advantageous embodiment, the control unit can also process and implement an operator request as regards the position and/or movement of the door leaf. It is thus, for instance, feasible for the door leaf not only being braked within the aforementioned deceleration range but being held in a randomly selectable position within the braking range.

This, too, can be implemented by means of the magnetic arrangement if a respective current is applied to the two solenoid magnets. This holding request or respective holding command can be conveyed by the operator by, for instance, by actuation of a button evaluated by the control unit once the door leaf has reached the desired position. Naturally it is also feasible to specify such a holding point in advance in a program. Consequently, a respective menu control can be provided in the motor vehicle. The invention also covers determination of the door leaf by remote control. For this purpose the operator can, for instance, use a remote controllable key.

As a result, a motor vehicle door and a method for acting on said motor vehicle door in terms of braking/holding or pulling closed/opening is provided, characterised by a particularly high reliability, simple design and thus a particularly cost effective implementation. This is achieved as basically only a magnetic arrangement with at least two electric solenoids is required for the implementation. The electric solenoids are moved towards or away from each other during movement of the door leaf in relation to the motor vehicle body. The relative movement of the electric solenoids in relation to each other can in this context be provided by an anyway mostly present rack and pinion arrangement in the area of an axis of rotation of the door leaf. The magnetic arrangement can thus generally be placed in the area of a hinge axis, so that it is housed in a protected and space-saving manner. Alternatively, the magnetic arrangement can also be positioned in the vicinity of a motor vehicle door lock, mounted in or on the door leaf. Alternatively or in addition, arrangement on a column or generally on the motor vehicle body is also feasible. It is therefore naturally within the framework of the invention that, for instance, an electric solenoid is mounted in the area of the motor vehicle door lock and the other electric solenoid in or on, for instance a B column. Generally, the magnetic arrangement is, however, positioned in the area of the hinge axis of the door leaf, as explained in detail below.

Below the invention is explained with reference to a drawing showing only one embodiment, in which:

### BRIEF DESCRIPTION OF THE DRAWINGS

FIG. 1 shows a schematic overview of the motor vehicle door in a first embodiment

FIG. 2 shows a turned away motor vehicle door according to the invention and

FIG. 3 shows a schematic view of a motor vehicle door according to FIGS. 1 and 2.

### DETAILED DESCRIPTION OF THE DRAWINGS

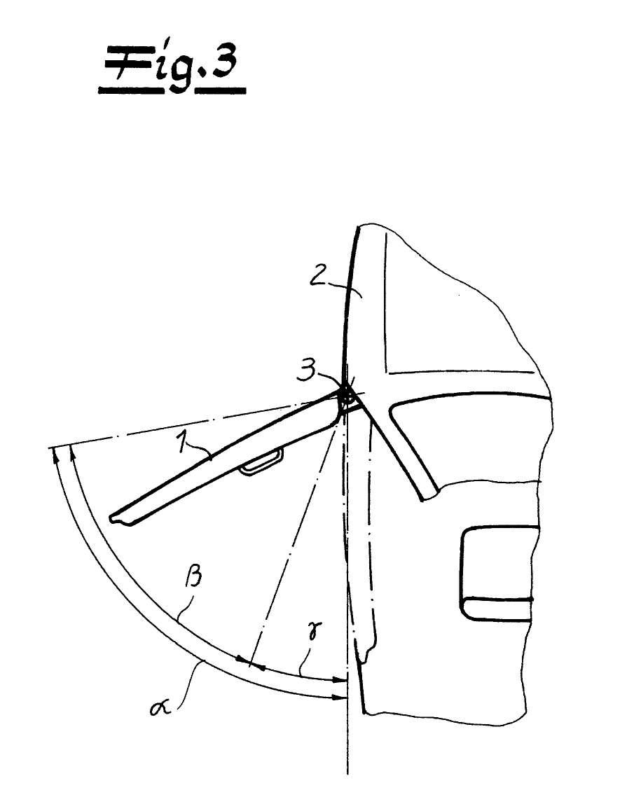

The figures show a motor vehicle door equipped with a door leaf 1 that can be pivoted around a hinge axis 3 in relation to a motor vehicle body 2 in the method shown in FIG. 3 and taking into consideration a total pivoting angle α that said door leaf can be pivoted by. The motor vehicle door is thus a motor vehicle side door although the arrangements for a tailgate are similar.

The maximum pivoting angle α that said door leaf 1 can be pivoted by, determines a respective pivoting area. This pivoting area or pivoting angle α is as such divided into a braking area or braking angle β and a closing/opening range or a respective closing/opening angle 7. The closing/opening angle γ corresponds to an angle of approx. 0° to approx. 10° to 15° or even 20° compared to the motor vehicle body 2. The closing/opening angle γ is followed by the braking angle β of approx. 60° to 70°, consequently exceeding the area of approx. 10° or 15° up to the maximum pivot angle of around 80° in the example (see FIG. 3).

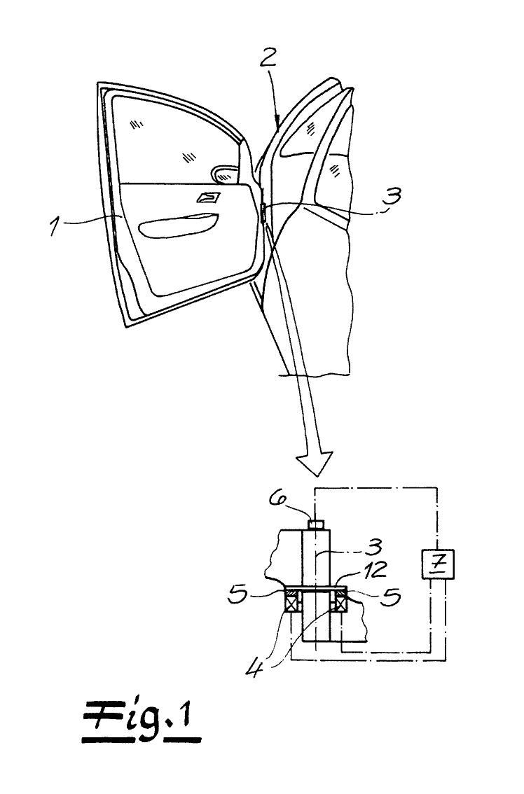

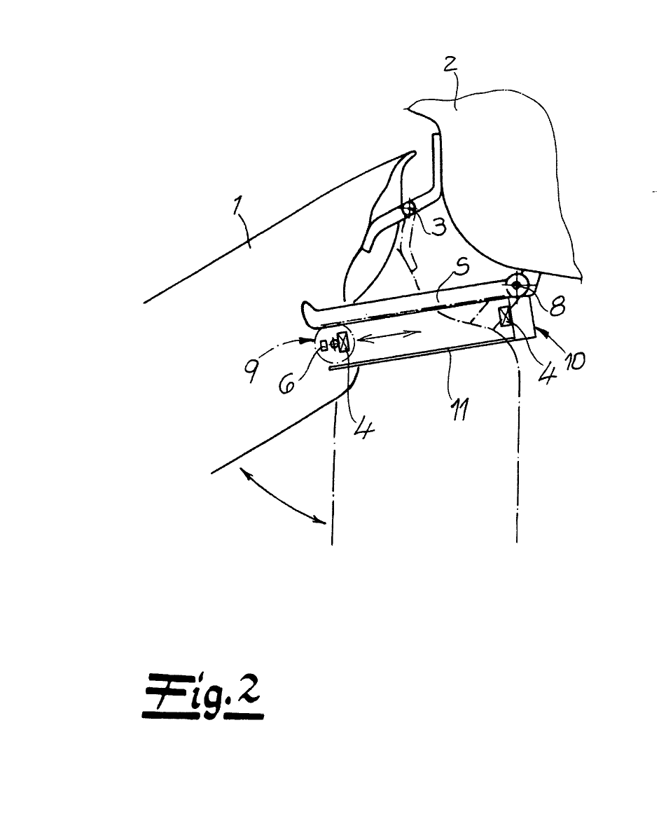

FIGS. 1 and 2 show that apart from door leaf 1 the motor vehicle door contains a drive 4, 5 or 4. In the example shown in FIG. 1, the drive 4, 5 comprises two electric solenoids 4 and several permanent magnets 5, arranged in ring-like fashion in relation to the hinge axis 3. In the embodiment shown in FIG. 2 only two electric solenoids 4 are provided as a drive 4.

In both cases, a magnetic arrangement 4 in form of the two electric solenoids 4 is a part of the electric drive 4, 5 or 4. In the example, the magnetic arrangement 4 or the magnetic arrangement 4 including permanent magnets 5 and the respective drive 4, 5 or 4 are congruent. Lastly, the basic arrangement also contains at least a sensor 6 assigned to the door leaf 1. The sensor 6 is a speed/position sensor and, in the embodiment, a step counter 6 or incremental encoder. The sensor 6 or step counter 6 is arranged on the same axis as the hinge axis 3 in FIG. 1. In the option shown in FIG. 2, the sensor or step counter 6 interacts with a rack and pinion drive 5, which in relation to a respective axis of rotation 8 is pivotably arranged inside the motor vehicle body 2. As soon as the door leaf 1 in the option of FIG. 2 is closed or opened in relation to the motor vehicle body 2, a gear wheel 9 accommodating the sensor 6 moves in relation to the rack and pinion drive 5 or rolls off it. This again allows determination of the position of the door leaf 1 in relation to the motor vehicle body 2 and of its speed by means of the sensor or step counter 6.

The sensor or step counter 6 actually provides information about the position of the door leaf 1 in relation to the motor vehicle body 2 or—in FIG. 3—i.e. which pivoting angle α the door leaf 1 is presently assuming in relation to motor vehicle body 2. The sensor or the step counter 6 also informs a connected control unit 7 of the speed of the door leaf 1 and the direction it is being moved in, i.e. whether it is closing or opening (see FIG. 1).

All of this information is processed by the control unit 7 and translated into energizing signals for the two electric solenoids 4 acted upon by the control unit 7 on its output side. In this context, the two electric solenoids 4 can optionally be acted upon in the sense of mutual repelling or mutual attracting in relation to the embodiment shown in FIG. 2. Alternatively, the two electric solenoids 4 are energised in the sense of repelling/attracting in relation to the additional permanent magnets 5 as part of the option shown in FIG. 1.

The energising of the magnetic arrangement 4 or of the two electric solenoids 4 is regularly based on the signals of the sensor 6 processed by the control unit 7 and in the sense of a control. For this purpose, the control unit 7 contains respective reference values or set values and, for instance, for the speed of the door leaf 1. If the door leaf 1 thus exceeds, for instance, the speed during one closing operation of the door leaf 1, the sensor 6 records the respective closing speed and the control unit 7 ensures in this case that the door leaf 1 is braked. During this operation, the electric solenoids 4 are acted on in a way that their braking effect is such that the door leaf 1 does not exceed the maximum speed specified as a set value. It is, for instance feasible to limit this maximum speed of the door leaf 1 to 1 m/sec. or less.

The interaction between the two electric solenoids 4 in the embodiment shown in FIG. 2 is such that the right electric solenoid 4 in the example is arranged fixed in position on a bracket 10. In contrast, the left solenoid 4 in FIG. 2 is moved around the axis or hinge axis 3 and in a linear manner, as indicated by the arrow in FIG. 2 during movement of the door leaf 1 in relation to the motor vehicle body 2. The movement of the door leaf 1 thus corresponds to the left electric solenoid 4 moving in relation to the bracket 10.

For this purpose, the left electric solenoid 4 is connected to the gear wheel 9, combing with the rack and pinion drive 5. The left electric solenoid 4 is actually moved in relation to a guide rod 11 to and fro as part of the bracket 10 and during a closing movement of the door leaf 1 for the purpose of reducing the distance to the fixed right electric solenoid 4 and during an opening movement of the door leaf 1 in relation to the motor vehicle body 2 in such a way that the distance to the fixed electric solenoid 4 is increased.

Where in this scenario the electric solenoids 4 are energised in such a way that the same poles, i.e. in each case the north poles are facing each other, the electric solenoids 4 coming closer to each other result in repelling forces that increase as the gap reduces and ultimately cause the door leaf 1 is stopped.

From a certain distance between the electric solenoids 4, corresponding to the door leaf moving from the braking range or the associated braking angle B into the closing/opening angle or the respective closing/opening angle 11, the electric solenoids 4 are typically energised in such a way that they no longer form the same but opposing magnetic poles. This means that the interaction between the two electric solenoids 4 moves from a repelling to an attracting force. In the closing/opening range or the respective closing/opening angle γ, this attracting force is used to close the door leaf 1 in relation to the motor vehicle body 2. In contrast, the electric solenoids 4 are repelling in relation to the motor vehicle body in the braking area or in case of a braking angle β of the door leaf 1. This means that in case of an attraction, the drive 4 or the magnetic arrangement 4 also act as a closing aid.

Vice versa it is also feasible that the drive 4, 5 or 4 or the magnetic arrangement 4 operates as an opening aid or pushing-out aid, thus ensuring that when the motor vehicle door lock is open, the door leaf 1 is pushed out in relation to the car body 2. In most cases the door leaf 1 is pushed out so far that it exceeds the closing/opening angle γ after completion of the pushing-out step.

In the alternative embodiment shown in FIG. 1 no attracting or repelling forces between the electric solenoids 4 are used but instead, repelling/attracting forces between the electric solenoids 4 and respective permanent magnets 5, arranged in a ring-like manner. FIG. 1 shows that the permanent magnets 5 are arranged along a ring with alternating magnetic poles, arranged in a circular manner in relation to the hinge axis 3 above the respective electric solenoids 4.

With the aid of the control unit 7, the electric solenoids 4 can now be cyclically acted upon so that optionally an attracting or repelling effect can be observed between the respective permanent magnets 5 and the magnetic pole arranged opposite on the head of the electric solenoid 4 or even both, in particular when, for instance, the left electric solenoid 4 attracts the permanent magnet 5 arranged above it, whilst the right electric solenoid 4 is repelled in this context.

The sensor 6 always informs the control unit 7 about which permanent magnet 5 is in a position above the electric solenoid 4 to be acted upon. Where, for instance, magnetic North poles are located opposite the head of the associated electric solenoid 4 or in close proximity to this head, the control unit 7 can act on the electric solenoid 4 in such a way that they attract the permanent magnet 5. In order to achieve this, the permanent magnet coil 4 is controlled in such a way that a South pole forms at the head. As the permanent magnets 5 are as a whole arranged on a disc 12 connected to the hinge axis 3 and the door leaf 1, this operation corresponds to the door leaf 1 being slowed down.

The design can also be such that changing magnetic fields of the solenoids 4 are used in such a way that the disc 12 is being rotated. This will typically occur where the door leaf 1 exceeds the closing/opening angle γ and is to be acted upon, for example, in closing or opening sense e.g. for pulling closed or opening i.e. for pulling in the door leaf 1 or pushing out of said door leaf.

In any case it is clear as such that as a result of the interaction between the two electric solenoids 4 or their interaction with the permanent magnets 5, the door leaf 1 can be moved in the sense of braking/holding or closing/opening. This is ultimately ensured by the magnet arrangement 4 or the drive 4 or 4, 5 collectively and depending on the signals of the sensor 6 processed by the control unit 7.

1. Motor vehicle door equipped with a door leaf (1) and a drive (4; 4, 5), as well as a magnetic arrangement (4) as part of the drive (4; 4, 5) and with at least one sensor (6) assigned to the door leaf (1), characterised in that, depending on the speed and/or position of the door leaf (1) in relation to a motor vehicle body (2) determined with the aid of the sensor (6), the magnetic arrangement (4) for selectively braking, holding, pulling closed or opening the door leaf (1) is energised by a control unit (7).

2. Motor vehicle door according to claim 1, characterised in that the sensor (6) is designed as a speed/position sensor.

3. Motor vehicle door according to claim 2, characterised in that the sensor (6) is a step counter (6).

4. Motor vehicle door according to claim 3, characterised in that the magnetic arrangement (4) contains at last two electric solenoids (4) and, where applicable, permanent magnets (5).

5. Motor vehicle door according to claim 4, characterised in that the two electric solenoids (4) are selectively energised in the sense of mutual repelling, mutual attracting and in the sense of a repelling/attracting of the additional permanent magnets (5).

6. Motor vehicle door according to claim 5, characterised in that the magnetic arrangement (4) is energised in accordance with signals of the sensor (6) processed in the control unit (7) in the sense of a control.

7. Method for acting on a door leaf (1) of a motor vehicle door in the sense of braking/holding or closing/opening, in which the motor vehicle door contains a door leaf (1) with a drive (4; 4, 5), as well as a magnetic arrangement (4) as part of said drive (4, 5; 4) and at least a sensor (6) assigned to the door leaf (1), in which the sensor (6) determines the speed and position of the door leaf (1) in relation to a motor vehicle body (2) and transfers this to a control unit (7), after which the control unit (7), depending on the signals of the sensor (6), energises the magnetic arrangement (4) in such a way that the door leaf (1) is selectively braked, held, or pulled closed, opened or pushed out.

8. Method according to claim 7, characterised in that the sensor (6) detects the speed and position of the door leaf (1) in relation to the motor vehicle body (2) and transfers this information to the control unit (7).

9. Method according to claim 8, characterised in that according to the position and speed of the door leaf (1) in relation to the motor vehicle body (2), the control unit (7) acts on the magnetic arrangement (4) in the sense of braking/holding or closing/opening.

10. Method according to claim 9, characterised in that the control unit (7) also processes and implements an operator request relating to the position and/or movement of the door leaf (1).

11. Method according to claim 7, characterised in that the control unit (7) also processes and implements an operator request relating to the position and/or movement of the door leaf (1).

12. Method according to claim 8, characterised in that the control unit (7) also processes and implements an operator request relating to the position and/or movement of the door leaf (1).

13. Method according to claim 7, characterised in that according to the position and speed of the door leaf (1) in relation to the motor vehicle body (2), the control unit (7) acts on the magnetic arrangement (4) in the sense of braking/holding or closing/opening.

14. Method according to claim 13, characterised in that the control unit (7) also processes and implements an operator request relating to the position and/or movement of the door leaf (1).

15. Motor vehicle door according to claim 1, characterised in that the magnetic arrangement (4) contains at last two electric solenoids (4) and, where applicable, permanent magnets (5).

16. Motor vehicle door according to claim 2, characterised in that the magnetic arrangement (4) contains at last two electric solenoids (4) and, where applicable, permanent magnets (5).

17. Motor vehicle door according to claim 1, characterised in that the magnetic arrangement (4) is energised in accordance with signals of the sensor (6) processed in the control unit (7) in the sense of a control.

18. Motor vehicle door according to claim 2, characterised in that the magnetic arrangement (4) is energised in accordance with signals of the sensor (6) processed in the control unit (7) in the sense of a control.

19. Motor vehicle door according to claim 3, characterised in that the magnetic arrangement (4) is energised in accordance with signals of the sensor (6) processed in the control unit (7) in the sense of a control.
